(19) United States
(12) Patent Application Publication
(10) Pub. No.: US 2003/0059653 A1
(43) Pub. Date: Mar. 27, 2003

(54) Film of yttria-alumina complex oxide, a method of producing the same, a sprayed film, a corrosion resistant member, and a member effective for reducing particle generation

(75) Inventors: Hirotake Yamada, Anjyo City (JP); Tsuneaki Ohashi, Nagoya-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 10/197,037

(22) Filed: Jul. 17, 2002

(30) Foreign Application Priority Data
Jul. 19, 2001 (JP) P2001-219,092
Jun. 21, 2002 (JP) P2002-180,769

(51) Int. Cl. B32B 9/00; B05D 1/02; B32B 18/00

(52) U.S. Cl. 428/702; 427/180; 427/421; 428/697; 428/332; 428/304.4

(57) ABSTRACT

An object of the invention is to provide a film of an yttria-alumina complex oxide having a high peel strength of the film to a substrate. A mixed powder of powdery materials of yttria and alumina is sprayed on a substrate to form a sprayed film made of an yttria-alumina complex oxide. Preferably, the powdery material of yttria has a 50 percent mean particle diameter of not smaller than 0.1 μm and not larger than 100 μm, and the powdery material of alumina has a 50 percent mean particle diameter of not smaller than 0.1 μm and not larger than 100 μm. Preferably, the yttria-alumina complex oxide contains at least garnet phase, and may further contain perovskite phase.

This application claims the benefits of Japanese Patent Applications P2001-219, 092, filed on Jul. 19, 2001, and P2002-180, 769, filed on Jun. 21, 2002, the entireties of which are incorporated by reference.

### BACKGROUND OF THE INVENTION

1. Title of the Invention

The invention relates to a method of producing a film of an yttria-alumina complex oxide, a film of an yttria-alumina complex oxide, a sprayed film, a corrosion-resistant member and a member effective for reducing particle generation.

2. Related Art Statement

In a semiconductor manufacturing system requiring super clean state, halogen-based corrosive gases such as a chlorine-based gas and fluorine-based gas are used as a deposition gas, etching gas and cleaning gas. For example, it is used a cleaning gas for a semiconductor composed of a halogen-based corrosive gas such as ClF₃, NF₃, CF₄, HF and HCl after a deposition stage in a semiconductor producing system such as a hot CVD system. Further, a halogen-based corrosive gas such as WF₆, SiH₂Cl₂ or the like is used for film formation in a deposition stage.

Further, in film-forming and etching stages of a CVD or PVD process, the chemical reaction for film formation or etching produces by-products, which are deposited onto a susceptor, electrode or parts constituting a chamber. Particularly in a system of so-called cold wall type, the chamber wall is low in the temperature, so that particles may be easily deposited onto the cold chamber wall. Although such deposits are subjected to a cleaning process of dry or wet process at a predetermined interval, too much deposits may be fallen or moved onto a semiconductor wafer, resulting in instability of semiconductor processing or reduction of a production yield.

For preventing the falling of particles, it has been known to apply a shot peening or blast treatment using glass beads on the surface of a metal plate to increase the surface roughness, so that the retention force of the metal surface may be improved.

### SUMMARY OF THE INVENTION

It has been thus desired to form a film being highly resistive against a halogen-based gas or its plasma and stable for a long time period on a member used for a semiconductor-producing system, such as a member contained in the chamber or the inner wall surface of the chamber. Further, when by-products are deposited on a member contained in the system or the inner wall surface of the chamber, it is desired to hold the deposited by-products for a long time period.

The assignee filed a Japanese patent application P2001-110, 136. According to the disclosure, it is possible to form a film of an yttria-alumina complex oxide on a substrate by spraying and to provide a high anti-corrosion property against a halogen-based gas plasma, thus preventing the particle generation. The corrosion-resistant film, however, might leave the following problems. That is, cracks may be induced in the film depending on the conditions for spraying. The sprayed film may be subjected to a heat treatment at a high temperature. Such heat treatment may induce cracks in the film. If cracks are generated in the film of an article having a substrate and the film, such film may be easily peeled from the substrate to generate particles and reduce the anti-corrosion property against a corrosive substance. The resulting article may be undesirable, thus reducing the production yield.

An object of the present invention is to provide a film of an yttria-alumina complex oxide having a high peel strength to a substrate.

Another object of the invention is to provide a member effective for reducing particle generation having a high retention capability of deposits and usable for a long time period with improved stability.

Still another object of the invention is to provide a member effective for reducing particle generation having a high retention capability of deposits on the surface, so as to reduce particles due to the deposits on the member and a down time associated with maintenance of a system applying the member.

A first aspect of the invention provides a method of producing a film of an yttria-alumina complex oxide, the method comprising the step of:

spraying a mixed powder of powdery materials of yttria and alumina onto a substrate to produce a sprayed film composed of an yttria-alumina complex oxide.

Further, the invention provides a film of an yttria-alumina complex oxide obtained by the above method.

Further, the invention provides a film of an yttria-alumina complex oxide, wherein the yttria-alumina complex oxide comprises those of garnet and perovskite phases and a ratio YAL(420)/YAG(420) is not lower than 0.05 and not higher than 1.5, provided that the ratio YAL(420)/YAG(420) is the ratio of a peak strength YAL (420) of the (420) plane of the perovskite phase to a peak strength YAG (420) of the (420) plane of the garnet phase. The peak strengths are measured by X-ray diffraction method.

Further, the invention provides a film formed by spraying, the film being made of an yttria-alumina complex oxide and free from a crack having a length of not smaller than 3 μm and a width of not smaller than 0.1 μm.

Further, the invention provides a corrosion-resistant member comprising a substrate and a film of an yttria-alumina complex oxide, wherein the yttria-alumina complex oxide comprises those of garnet and perovskite phases and a ratio YAL(420)/YAG(420) is not lower than 0.05 and not higher than 1.5, provided that the ratio YAL(420)/YAG(420) is the ratio of a peak strength YAL (420) of the (420) plane of the perovskite phase to a peak strength YAG (420) of the (420) plane of the garnet phase. The peak strengths are measured by X-ray diffraction method.

The invention further provides a corrosion-resistant member comprising a substrate and a film formed by spraying. The film is made of an yttria-alumina complex oxide and free from a crack having a length of not smaller than 3 μm and a width of not smaller than 0.1 μm.

Further, a second aspect of the invention provides a member effective for reducing particle generation and comprising a substrate and a surface layer on the substrate. The surface layer has α calculated according to the following formula of not lower than 50 and not higher than 700.

α=(a specific surface area measured by Krypton adsorption method (cm²/g))×(a thickness of the surface layer (cm))×(a bulk density of the surface layer (g/cm³))

The inventors have an idea of spraying a mixed powder of powdery materials of yttria and alumina on a substrate to form a sprayed film of an yttria-alumina complex oxide, and tried the process. Consequently, they have successfully formed a film having a high peel strength to a substrate with improved stability.

The thus obtained film of an yttria-alumina complex oxide do not have substantial cracks with a high peel strength to the underlying substrate, thereby preventing the peeling of the film and particle generation in contact with a corrosive substance. Additionally, when such film is subjected to a heat treatment, the peel strength of the film to the substrate may be further improved with cracks not observed in the film after the heat treatment.

Moreover, it is possible to control or regulate the microstructure of the film by controlling the conditions for the spraying process and for the heat treatment. Specifically, a porous film substantially without closed pores, or a porous film having a high ratio of open pores to closed pores may be successfully produced. A member for a semiconductor-producing system may be advantageously produced using such film and the underlying substrate. Such member has an improved specific surface area, so that deposits may be firmly hold on the surface of the member by anchor effect to reduce the thickness of the deposits on the member. It is thus possible to produce a film having a specific a value according to the invention of the second aspect, which will be described later in detail.

In a preferred embodiment, the powdery material of yttria has a 50 percent mean particle diameter of not smaller than 0.1 μm and not larger than 100 μm, for further reducing the crack formation and improve the anti-corrosion property against a corrosive substance such as a halogen-based gas.

The powdery material of yttria may preferably has a 50 percent mean particle diameter of not smaller than 0.5 μm, and more preferably not smaller than 3 μm, for further improving the adhesive strength of a film to a substrate. The 50 percent mean particle diameter of the powdery material of yttria may preferably be not larger than 80 μm, more preferably be not larger than 50 μm and most preferably be not larger than 10 μm, for further improving the adhesive strength of the film to the substrate.

In a preferred embodiment, the powdery material of alumina may preferably has a 50 percent particle diameter of not smaller than 0.1 μm and not larger than 100 μm. It is thus possible to further reduce the crack formation and to further improve the anti-corrosion property of the film against a corrosive substance such as a halogen based gas.

The 50 percent particle diameter of the powdery material of alumina may preferably be not smaller than 0.3 μm and more preferably be not smaller than 3 μm, for further improving the adhesive strength of the film to the substrate. The 50 percent mean particle diameter of the powdery material of alumina may preferably be not larger than 80 μm, more preferably not larger than 50 μm and most preferably not larger than 10 μm, for further improving the adhesive strength of the film to the substrate.

The 50 percent mean particle diameter (D50) is calculated based on the diameters of primary particles when secondary particles are not observed, and the diameters of secondary particles when the secondary particles are observed, in both of the powdery materials of yttria and alumina.

The mixed ratio of the powdery materials of yttria and alumina is not particularly limited. The ratio (yttria/alumina), however, may preferably be 0.2 to 1, and more preferably be 0.5 to 0.7, calculated based on the molar ratio of yttria and alumina molecules.

The mixed powder may contain a powdery material of a third component other than yttria powder and alumina powder. It is, however, preferred that the third component does not adversely affect the crystalline phases, such as garnet and perovskite phases, of an yttria-alumina complex oxide, which will be described later. More preferably, the third component is a component capable of replacing the sites of yttria or alumina in the garnet or perovskite phases of an yttria-alumina complex oxide. The third component may preferably be selected from the followings.

La₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃, La₂O₃, MgO, CaO, SrO, ZrO₂, CeO₂, SiO₂, Fe₂O₃, B₂O₃

When spraying the mixed powder, the mixed powder may be sprayed on a substrate without substantially adding an additive. Alternatively, a binder and a solvent may be added to the mixed powder to produce granules by means of spray drying, and the granules may then be sprayed.

The mixed powder may preferably be sprayed under a low pressure. The pressure may preferably be not higher than 100 Torr, for further reducing the pores in the sprayed film and for enhancing the corrosion resistance of the resultant film.

In a preferred embodiment, the sprayed film may be subjected to a heat treatment, for further improving the peel strength of the film to the substrate.

The film may preferably be heat treated at a temperature not lower than 1300° C. and more preferably not lower than 1400° C. It is considered that a layer of a reaction product may be formed along the interface between the substrate and film by increasing the temperature for the heat treatment not lower than 1300° C., so that the peel strength may be improved.

The temperature for the heat treatment has no particular upper limit, so long as the substrate is not degraded or decomposed. The temperature for the heat treatment may preferably be not higher than 2000° C. for preventing the degradation of the substrate. When the temperature for the heat treatment of the sprayed film approaches 1800° C., aluminum elements may move and diffuse around the layer of a reaction product once formed along the interface between the film and substrate. Such movement may inversely reduce the peel strength of the corrosion-resistant film. From this point of view, the temperature for the heat treatment may preferably be not higher than 1800° C. Further, the temperature may preferably be not higher than 1700° C. for preventing crack formation in the film.

This film may be formed continuously over the surface of the substrate. The film, however, may be and may not be formed continuously over the entirety of a predetermined face of the substrate. For example, The film may be formed discontinuously on the surface of the substrate. The film also may be formed as a plurality of layer-like islands. In this case, such layer-like islands are not continuous to one another. Alternatively, the film may exist in a dotted manner or are scattered on a predetermined surface of the substrate.

In a preferred embodiment, the inventive film is substantially free from cracks. Particularly, the inventive film is free from a crack having a length of not smaller than 3 μm and not smaller than 0.1 μm. The presence of such microcracks may be detected by observing a film using a scanning electron microscope applying a magnitude of not lower than 1000.

The material of a substrate is not particularly limited. Preferably, the material does not contain an element which might adversely affect a process carried out in a container for plasma generation. From this point of view, the material of a substrate may preferably be aluminum, aluminum nitride, aluminum oxide, a compound of aluminum oxide and yttrium oxide, a solid solution of aluminum oxide and yttrium oxide, zirconium oxide, a compound of zirconium oxide and yttrium oxide, and a solid solution of zirconium oxide and yttrium oxide.

The peel strength of the corrosion-resistant film to the substrate is measured by Sebastians test, assuming that the diameter of the bonded face is 5.2 mm.

The substrate may be porous. The center line average surface roughness Ra of the surface of the substrate may be not smaller than 1 μm and more preferably be not smaller than 1.2 μm. It is thus possible to improve the adhesive strength of the film to the underlying substrate and to reduce the particle generation due to the peeling of the film.

The kind of an yttria-alumina complex oxide is not particularly limited, and may be selected from the followings.

(1) Y₃AL₅O₁₂(YAG:3Y₂O₃.5Al₂O₃)

This oxide contains yttria and alumina in a molar ratio of 3:5 and has garnet crystalline phase.

(2) YAlO₃(YAL:Y₂O₃.Al₂O₃) perovskite crystalline phase

(3) Y₄Al₂O₉(YAM:2Y₂O₃.Al₂O₃) monoclinic system

In a preferred embodiment, the yttria-alumina complex oxide contains at least garnet phase. Further in a preferred embodiment, the yttria-alumina complex oxide contains garnet and perovskite phases. It is thereby possible to further improve the peel strength of the film to the substrate and to reduce crack formation.

Particularly preferably, the yttria-alumina complex oxide contains garnet and perovskite phases. A ratio YAL(420)/YAG(420) is not lower than 0.05 and not higher than 1.5. The ratio YAL(420)/YAG(420) is the ratio of a peak strength YAL (420) of the (420) plane of the perovskite phase to a peak strength YAG (420) of the (420) plane of the garnet phase. The peak strengths are measured by X-ray diffraction method.

YAL(420)/YAG(420) may preferably be not lower than 0.05, or not higher than 0.5.

The inventive film, or laminate of the film and a substrate, has a superior anti-corrosion property, especially against a halogen-based gas or a plasma of a halogen-based gas.

The corrosion resistant member according to the invention may be used for a system of producing semiconductors such as thermal CVD system to make use of its anti-corrosion property. In a system for producing semiconductors, a semiconductor cleaning gas of a halogen-based corrosive gas is used. The corrosion resistant member according to the invention is corrosion resistant against a plasma of a halogen-based gas, as well as a plasma of a mixed gas of a halogen gas and oxygen gas.

Such halogen gas includes ClF₃, NF₃, CF₄, WF₆, Cl₂, BCl₃ or the like.

The second aspect of the invention provides a member effective for reducing particle generation comprising a substrate and a surface layer on the substrate. The layer has a specific surface area per a n unit area “α” of not lower than 50 and not higher than 700.

When generated by-products and particles deposit on the surface of the member, the deposited by-products and particles may be held in pores of the surface layer, thus preventing the falling or dispersing of the by-products and particles from the surface layer. It is thus possible to reduce defects of semiconductors due to the falling and dispersing of the particles and thereby to reduce a down time of an entire system for cleaning the deposits on the member.

A specific surface area per an unit area “α” is defined according to the following formula.

α=(a specific surface area measured by Krypton adsorption method (cm²/g))×(a thickness of the surface layer (cm))×(a bulk density of the surface layer (g/cm³))

As can be seen from the above formula, “α” is a kind of index indicating a specific area per an unit surface area of a surface layer. The surface area of the surface layer may be calculated, for example, from a design drawing. More specifically, the surface area is calculated on the assumption that the surface is smooth without any irregularities formed on the surface of the layer.

The specific surface area measured by Krypton adsorption method (cm²/g) means a specific surface area (cm²) per an unit weight (g). That is, the specific surface area means the adsorption capacity per an unit weight of a surface layer. In other words, that means the amount and diameters of open pores effective for adsorption per an unit weight of an surface layer.

On the other hand, the thickness (cm) of a surface layer is multiplied by the bulk density of the surface layer (g/cm³) to obtain a weight per an unit surface area of the layer (g/cm²). The weight per an unit surface area of the layer (g/cm²) is then multiplied by the specific surface area measured by Krypton adsorption method (cm²/g) to obtain a specific surface area per an unit surface area (cm²/cm²), which is “α”. “α” is therefore an index indicating the adsorption capacity of a gas, or the amount and diameters of open pores, per an unit surface area (1 cm²) of the surface layer. A bulk density is a density calculated by dividing a weight by a volume containing open pores and closed pores.

“α” has to be controlled to a value not lower than 50 in the invention. A surface layer having such large specific surface area per an unit area “α” is provided on a substrate, according to the invention, so that the by-products and particles may thereby adsorbed, adhered or hold in open pores in the surface layer. It is thereby possible to reduce the falling or dispersion of particles from the surface layer. From this point of view, “α” may preferably be not larger than 100.

When “α” is small, the surface area for holding and adsorbing the by-products is insufficient, so that the by-products deposit on the surface layer to form a thicker deposits to increase the deposits fallen from the surface layer, even when the amount of the generated by-product is not increased. Such thicker deposits increase the by-products fallen from the surface layer. Additionally, the surface area exhibits relatively poor anchor effect, so that the holding capacity of the by-products in the surface layer may be reduced.

Besides, “α” of not smaller than 50 is apparently larger than that of conventional members produced by blasting well known in a shield plate or the like used for a sputtering system (see comparative examples C1, and C2: tables 3 and 4).

When a specific surface area per an unit area “α” of the surface layer is made large, the surface area for adsorbing the by-products and particles is also increased. It may be therefore speculated that the increased “α” is advantageous for preventing the falling and dispersion of the particles and by-products. Contrary to the speculation, it is found that when “α” is beyond 700, the amount of fallen and dispersed particles is increased. The results may be explained as follows. If “α” is beyond 700, ceramic bone structure constituting the surface layer is fractured microscopically when thermal cycles are applied. Such fracture may contribute to the increase of the particles. From this point of view, “α” may preferably be not larger than 500, and more preferably be not larger than 300.

The effects, features and advantages of the invention will be appreciated upon reading the following description of the invention when taken in conjunction with the attached drawings, with the understanding that some modifications, variations and changes of the same could be made by the skilled person in the art.

### BRIEF DESCRIPTION OF THE DRAWINGS

FIG. 1(a) is a cross sectional view schematically showing a member effective for reducing particle generation, and

FIG. 1(b) is a cross sectional view schematically showing the member 1 after the corrosion.

### PREFERRED EMBODIMENTS OF THE INVENTION

The open porosity of the surface layer may preferably be not lower than 10 volume percent, and more preferably be not lower than 15 volume percent. It is thus possible to improve the holding capability of the by-products and particles in the surface layer. The open porosity of the surface layer may preferably be not higher than 30 volume percent. When the open porosity is higher than 30 volume percent, the corrosion resistance of the surface layer as well as the mechanical strength are reduced. The surface layer itself thus might become a source of generating particles or cracks might be introduced to increase the amount of particles.

The ratio of the open porosity to closed porosity (open porosity/closed porosity) of the surface layer may preferably be not lower than 10. Closed pores in the surface layer do not contribute to the retention and adsorption of the by-products and particles, and may accelerate the corrosion of the layer by a corrosive substance. The ratio of the open pores may preferably be higher.

In a preferred embodiment, the pore size of main open pores in the surface layer is 0.05 to 50 μm. It is thus possible to further improve the retention and adsorption of the by-products and particles in the open pores.

From another point of view, the pore size of the open pores may preferably be substantially same as or larger than that according to a design rule applied for producing semiconductor devices. For example, when the design rule of the device to be produced is 0.05 μm, the pore size may preferably be not lower than 0.05 μm.

The reasons will be described below. A wafer with fine grooves formed is stored and moved in N₂ atmosphere under an atmospheric pressure. N₂ and water content thus adsorb in the fine grooves formed in the wafer. When the wafer is subjected to a subsequent process such as etching or film-forming, it is necessary to remove N₂ and water content adsorbed in the fine grooves of the wafer for securing the process stability. The capacity of a discharge pump and specification of discharged system (diameter of a discharge tube, flow rate of a gas or the like) of a process chamber is usually designed sufficient for removing the gas contents from the fine grooves. The design rule is an index of the width of the fine grooves formed in the wafer. When the open pores in the inventive surface layer have a pore size of the same level as the design rule, gas contents in the open pores in the surface layer may be removed using the discharge pump and system. It is therefore considered that the open pores may not adversely affect the stability of the process in the process chamber.

The pore size of the open pores in the inventive film may be substantially same as the design rule. However, the inner wall surface of a chamber usually has a surface area substantially larger than that of a wafer to be treated. When the inner wall surface is made of the inventive film, the surface area of the inventive film is much larger than that of a wafer. In this case, the pore size of the open pores in the inventive film may preferably larger than the design rule.

Further, the thickness of the surface layer may preferably be not smaller than 50 μm and more preferably be not smaller than 100 μm, for improving the retention and adsorption of the by-products and particles.

On the other hand, the thickness of the surface layer may preferably be not larger than 1000 μm and more preferably be not larger than 400 μm, for improving the peel strength of the surface layer to the substrate and thus preventing particle generation.

The surface layer may be formed of a material not particularly limited, so long as the material has corrosion resistance required for an intended use. In a preferred embodiment, the material is selected from the group consisting of an oxide containing a rare earth element, an oxide containing an alkaline earth element, a carbide, a nitride, a fluoride, a chloride, an alloy, the solid solution thereof, and the mixture thereof The material may more preferably be one or more of the followings.

cordierite, diamond, silicon nitride, aluminum nitride, magnesium fluoride, calcium fluoride, aluminum fluoride.

Cordierite is a name of a mineral having a theoretical composition of 2 MgO-2Al₂O₃-5SiO₂, in which Fe or an alkaline content may be solubilized. Strictly speaking, cordierite is a name of the low-temperature phase of the composition, however its high-temperature phase is also usually called cordierite, which is included in the invention. The surface layer may be composed mainly of cordierite, with another additives and components allowed.

Cordierite contains MgO as its main ingredient and therefore has high corrosion resistance. When talc is used as a source of MgO, talc is liquefied during a heat treatment and moved into the grain boundaries of the surrounding particles. Consequently, spaces once occupied by the talc particles are made empty, leaving open pores. It is therefore possible to control the “α” value in a predetermined range by selecting the particle diameter of the talc particles or the like and conditions for the heat treatment. Talc is a name of a mineral having a theoretical composition of 3MgO.4SiO₂.H₂O.

A film of diamond may be formed on a substrate mainly by a CVD process. Diamond itself has an automorphic form of a pyramid or a rectangular parallelopiped. It is therefore possible to control the “α” value by selecting the size and shape of the automorphic form. Alternatively, a metal element such as Si may be mixed into a film of diamond, which is then subjected to etching using a fluorine-based plasma such as NF₃ to remove only the added metal element to control the “α” value. When applying a film of diamond, it is preferred to apply a substrate of silicon nitride, silicon carbide, aluminum nitride, Si, carbon or alumina.

Alternatively, it is possible to form a surface structure of silicon nitride having micro pores. For example, a silicon nitride sintered body is produced using sintering aids of Y₂O₃ and Al₂O₃. The sintered body is then subjected to a heat treatment in a fluorine-based plasma such as CF₄+O₂ at a temperature of 100 to 300° C. so that silicon nitride particles are selectively etched. A surface structure having micro pores of Y₂O₃.Al₂O₃.SiO₂ series oxide or an oxynitride of Y—Al—Si—N—O series may be thus produced. Alternatively, the silicon nitride sintered body may be subjected to a heat treatment in a molted salt of 300° C. composed of KOH:NaOH(1:1, molar ratio) to selectively dissolve the intergranular phases. A surface structure having micro pores mainly composed of silicon nitride may be thus produced.

As described above, the inventive film with a specific pore structure may be formed by spraying as well as sol-gel method, PVD, CVD, precipitation reaction from a solution or paste application process. Alternatively, the surface layer may be subjected to an etching process to form the inventive micro pore structure in the surface region.

In a particularly preferred embodiment, the surface layer is made of a compound containing yttrium. Such compound may preferably be yttria, a solid solution containing yttria, a complex oxide containing yttria, and yttrium trioxide. Specifically, it may be listed yttria, a solid solution of zirconia and yttria, a solid solution of a rare earth oxide and yttria, 3Y₂O₃.5Al₂O₃, YF₃, Y—Al—(O)—F, Y₂Zr₂O₇, Y₂O₃.Al₂O₃, 2Y₂O₃.Al₂O_{3.}

More preferably, the surface layer is composed of an yttria-alumina complex oxide formed by spraying a mixed powder of powdery materials of yttria and alumina on a substrate. The surface layer may be composed of the complex oxide as described above in explaining the first aspect of the present invention.

That is, in a preferred embodiment, the 50 percent mean particle diameter of the powdery material of yttria may preferably be not smaller than 0.1 μm and not larger than 100 μm. The 50 percent mean particle diameter of the powdery material of alumina may preferably be not smaller than 0.1 μm and not larger than 100 μm. The film formed by spraying may be subjected to a heat treatment. Further, the yttria-alumina complex oxide may preferably contain at least garnet phase. More preferably, the yttria-alumina complex oxide contain garnet and perovskite phases, and a ratio YAL (420)/YAG (420) is not smaller than 0.05 and not larger than 1.5. YAL (420) is the peak strength of the perovskite phase and YAG(420) is the peak strength of the garnet phase, both are measured by an X-ray diffraction analysis.

The member effective for reducing particle generation is to be exposed against a corrosive substance. The corrosive substance includes the followings. A fluorocarbon such as CF4, C3F6 or the like, oxygen, chlorine, boron chloride, CHF3, ClF3, SF6, NF3, HBr, TiCl4, WF6, SiCl4, hydrogen, and the mixed gas thereof. The corrosive substance may contain a carrier gas such as He, N₂ and Ar.

The corrosive substance may preferably be the halogen gases described above and its plasmas.

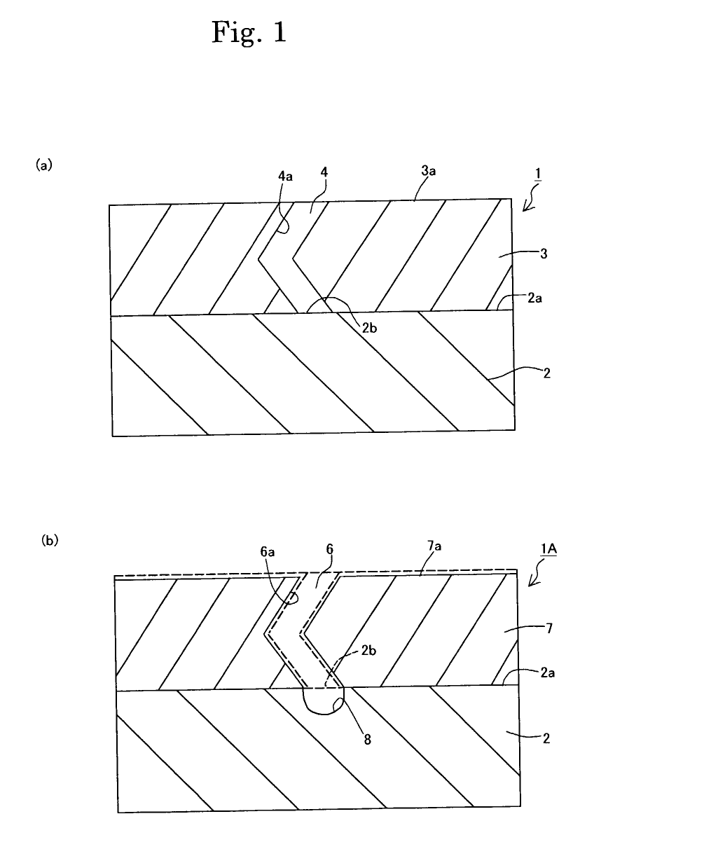

In the invention, the material of the substrate may have corrosion resistance lower than that of the material of the surface layer. The reasons will be described below. As shown in FIG. 1(a), a member 1 effective for reducing particle generation has a substrate 2 and a surface layer 3 formed on the surface 2a of the substrate 2. An open pore 4 communicates from the surface 3a of the surface layer 3 to the surface 2a of the substrate 2. 4a is an inner wall face of the open pore, and 2b is an exposed face of the substrate 2 facing the open pore. The open pore 4 has a small pore size as described above and the layer 3 has a some thickness. The open pore thus has an elongate shape of a relatively large aspect ratio.

When the member 1 is contacted with a corrosive substance, the surface layer 3 is corroded as shown in a solid line shown in FIG. 1(b). Dotted lines indicate the outline of the surface layer 3 before the corrosion. The surface 7a of the surface layer 7 is corroded, as well as the inner wall surface 6a of the open pore 6 and the exposed face 2b of the substrate 2. When the etching rate of the substrate 2 is larger than that of the surface layer 7 (susceptible to a corrosive substance), a relatively large hole 8 is formed on the exposed face 2a of the substrate 2. The etched hole 8 communicates with the open pore 6. On the other hand, the etching rate of the inner wall face 6a of the open pore 6 is relatively small, so that the pore size of the open pore 6 is not relatively unchanged after the corrosion. Consequently, the aspect ratio of the open pore 6 (including 8) is not largely changed, or even become larger, after the corrosion (the open pore is made elongated).

The substrate 2 is more susceptible to a corrosive substance in this case. Therefore, such elongate open pore with a relatively large aspect ratio is advantageous for preventing the contact of the substrate and a corrosive substance and for preventing particle generation from the substrate.

The substrate may be composed of a material not particularly limited. Preferably, the material does not contain an element which might adversely affect a process carried out in a container for plasma generation. From this point of view, the material of a substrate may preferably be aluminum, aluminum nitride, aluminum oxide, a compound of aluminum oxide and yttrium oxide, a solid solution of aluminum oxide and yttrium oxide, zirconium oxide, a compound of zirconium oxide and yttrium oxide, and a solid solution of zirconium oxide and yttrium oxide. In a particularly preferred embodiment, the substrate is composed of alumina, spinel, an yttria-alumina complex oxide, zirconia or the complex oxide thereof.

In a preferred embodiment, a compression force is applied onto the surface layer after forming the layer. The application of the force may be effective for preventing particle generation from the surface layer. The compression force may be applied by a heat treatment.

A method for controlling the “α” value (specific surface area per an unit area of a surface layer) is not particularly limited. Preferably, a mixed powder of powdery materials of yttria and alumina is sprayed onto a substrate to from a sprayed film, which is then subjected to a heat treatment, as described above. The powdery materials react with each other during the spraying step so that the volume is changed. Such volume change introduces many pores in the film. During the heat treatment of the sprayed film with many pores, the crystalline phase transformation further proceeds so that the film shrinks to increase the open porosity and “α” value. Such phenomenon is found by the present inventors.

Alternatively, the α″ value may be controlled by etching using an acidic solution or plasma, particularly by etching by means of selective corrosion. The “α” value may also be controlled by recent mechanical machining processes.

### EXAMPLES

Experiment A

Powdery materials each having an mean particle diameter (50 percent mean particle diameter) shown in table 1 were prepared among the diameters shown in table 1. Yttria particles (examples A1 to A3) with a mean particle diameter of 0.1, 0.5, or 5 μm are measured based on primary particles. The diameters of the other yttria particles (examples A4 to A8) are measured based on secondary particles. Alumina particles (examples A1 to A4) with a mean particle diameter of 0.1, 0.3, 4 and 20 μm are measured based on the primary particles and the other alumina particles (A5 to A8) are measured based on secondary particles.

In the examples A1 to A8 shown in table 1, powdery materials of yttria and alumina were mixed in a ratio of 57.1:42.9 based on weight. The molar ratio of yttria and alumina was 3:5. In the examples A1 to A3, powdery materials of yttria and alumina were wet mixed using a ball mill and granulated using a spray drier to obtain granules having a mean particle diameter of 40 μm. In the examples A4 to A8, powdery materials of yttria and alumina were dry mixed.

A plate-shaped substrate made of alumina (with a purity of 99.7 percent) having a length of 50 mm, a width of 50 mm and a thickness of 2 mm was prepared. The above mixed powder was plasma sprayed on the substrate using a plasma spraying system supplied by SULZER METCO. During the spraying, argon was supplied in a flow rate of 40 liter per minute and hydrogen was supplied in a flow rate of 12 liter per minute. The power for the spraying was 40 kW, and spray distance was 120 mm.

In the example A9, only the powder of yttria-alumina garnet (having a mean particle diameter of 40 μm was plasma sprayed on the substrate under the conditions described above. The thus obtained films of the examples were subjected to the following measurements.

Identification of Crystalline Phases

The crystalline phases in each film were identified using an X-ray diffraction system, according to the following conditions. YAL(420)/YAG(420) was then calculated.

CuKα, 50 kV, 300 mA, 2θ=20 to 70°

Applied system: Rotating anode type X-ray diffraction system “RINT” supplied by “Rigaku Denki”

Peel Strength

The peel strength was measured according to the following method.

1. A film-formed sample (laminate) is cut into a small test piece with a length of 10 mm, width of 10 mm and thickness of 2 mm (including the thickness of the film).

2. The cut piece is ultrasonically cleaned with acetone for 5 minutes.

3. An adhesive-provided Al stud pin (manufactured by Phototechnica Co., Ltd.) is prepared. This bonding area has a circle shape of 5.2 mm in diameter.

4. The pin is bonded to the film-formed side of the piece.

5. The pin bonded to the piece is fitted to a jig, and pulled up by an “AUTOGRAPH”, manufactured by Shimadzu Co., Ltd., until the film is peeled. The bonding strength is calculated from the bonding area and the load when the film is peeled (Peel strength=peeling load/bonding area of the pin). When the peeling occurs in the adhesive, the peeling load value is not used as a result of the measurement.

Observation of Cracks

The surface of each film was observed using a scanning electron microscope in a magnitude of 5000.

Corrosion Resistant Test

The sample of each example was set in a corrosion test system for performing the test under the following conditions. Each sample was held in Cl₂ gas (heater off) for 2 hours. The flow rate of Cl₂ gas was 300 sccm and that of a carries gas (argon gas) was 100 sccm. The gas pressure was set at 0.1 torr, and a power of RF 800W and a bias voltage of 310 W was applied. The weights of each sample before and after the exposure to Cl₂ gas were measured and the weight change was calculated.

TABLE 1

| | Mean particle | Mean particle | Ratio of | | | Weight | |
|---|---|---|---|---|---|---|---|
| | diameter of | diameter of | peak strength | Peel | Presence | Gain after | |
| | Y₂O₃ powder | Al₂O₃ | YAL (420)/ | strength | of | Corrosion test | |
| | (μm) | (μm) | YAG (420) | MPa | Cracks | mg/hr | |
| A1 | 0.1 | 0.1 | 0.000 | 8 | None | 0.0 | |
| A2 | 0.5 | 0.3 | 0.597 | 12 | None | 0.0 | |
| A3 | 5 | 4 | 0.324 | 30 | None | 0.0 | |
| A4 | 20 | 20 | 0.203 | 10 | None | 0.0 | |
| A5 | 50 | 50 | 0.108 | 12 | None | 0.1 | |
| A6 | 80 | 80 | 0.07 | 11 | None | 0.1 | |
| A7 | 100 | 100 | 0.05 | 10 | None | 0.1 | |
| A8 | 120 | 120 | | 13 | None | 0.7 | YAM phase |
| | | | | | | | observed |

| | | | | | |
|---|---|---|---|---|---|
| A9 | YAG powder only | 0.00 | 3 | Present | 1.2 |
| | (40 μm) | | | | |

As can be seen from table 1, in the example A9, powder of yttria-alumina garnet was sprayed on the substrate and perovskite phase was not observed in the resultant sprayed film. The peel strength of the film was relatively low with cracks observed. The weight gain after the corrosion test was also large. In the examples A1 to A8, the mixed powder was sprayed. The peel strength was relatively large with cracks not observed. In particular, when the mean particle diameter of yttria powder was 0.5 to 100 μm and that of alumina powder was 0.3 to 100 μm, the peel strength was not lower than 10 MPa, cracks were not observed and the corrosion resistance was considerably higher. In A8, the mean particle diameters of powdery materials of yttria and alumina were 120 μm, respectively, with YAM phase formed. In A8, the peel strength was as high as 13 MPa with the corrosion resistance slightly reduced.

Experiment B

The samples covered with the films of the examples Al to A9 were subjected to a heat treatment, respectively, at 1500° C. for 3 hours. The thus obtained films were evaluated as the experiment A and the results were shown in table 2.

TABLE 2

| | Mean particle | Mean particle | Temperature | Ratio of | | | Weight gain |
|---|---|---|---|---|---|---|---|
| | Diameter of | Diameter of | of heat | Peak strength | Peel | Presence | After |
| | Y₂O₃ | Al₂O₃ | treatment | YAL (420)/ | strength | Of | Corrosion test |
| | (μm) | (μm) | (° C.) | YAG (420) | MPa | Cracks | mg/hr |
| B1 | 0.1 | 0.1 | 1500 | 0.000 | 3 | Present | 0.7 |
| B2 | 0.5 | 0.3 | 1500 | 0.206 | 43 | None | 0.0 |
| B3 | 5 | 4 | 1500 | 0.258 | 48 | None | 0.0 |
| B4 | 20 | 20 | 1500 | 0.653 | 52 | None | 0.0 |
| B5 | 50 | 50 | 1500 | 0.996 | 45 | None | 0.1 |
| B6 | 80 | 80 | 1500 | 1.257 | 48 | None | 0.1 |
| B7 | 100 | 100 | 1500 | 1.385 | 45 | None | 0.1 |
| B8 | 120 | 120 | 1500 | 1.516 | 40 | None | 0.8 |

| | | | | | | |
|---|---|---|---|---|---|---|
| B9 | YAG powder only | 1500 | 0.00 | 3 | Present | 1.0 |
| | (40 μm) | | | | | |

As can be seen from table 2, in the example B9, perovskite phase was not observed in the film of the example B9. The peel strength was relatively small, cracks were not found and the weight gain was large after the corrosion test. In the examples A1 to A8, the mixed powder was sprayed and the peel strength was relatively large. In the example B1, however, the reduction of the peel strength and crack formation were observed. In particular, when the particle diameter of yttria powder was 0.5 to 100 μm and the particle diameter of alumina powder was 0.3 to 100 μm, the peel strength was considerably improved to a value over 40 MPa and cracks were not observed.

In the examples B4 to B8, the peak strength of YAL phase was considerably improved after the heat treatment. The tendency was considerable in the examples B6, B7 and B8. In the example A8, the ratio of peak strengths YAL(420)/YAG(420) was higher than 1.5 with cracks not observed and the peel strength not considerably reduced. However, the weight gain after the corrosion test was larger. This is due to the difference of the crystalline phases constituting the films.

As described above, the invention may provide an yttria-alumina complex oxide film with a high peel strength of the film to a substrate.

Experiment C

The members of examples C1 to C16 shown in tables 3 and 4 were produced. In the example C1, a dense alumina sintered body was finished by blasting using #80 abrasive grains and machined to a thickness of about 400 μm to obtain a self-standing test sample. In C2 and C3, YAG powder with a mean particle diameter of 40 μm was sintered at 1600° C. or 1500° C. to produce each sintered body. Each sintered body were then finished by blasting using #80 abrasive grains and machined to a thickness of about 400 μm to obtain a self-standing test sample.

In each of the examples C4 to C16, a sprayed film was formed as described in the experiment A on each of two substrates. The substrate has a length of 150 mm, width of 150 mm and thickness of 5 mm. The thus obtained sprayed film was subjected to a heat treatment in the examples C4 and C8 to C16. The ratio of the peak strengths, peel strength, the presence of cracks, results of corrosion resistant test, porosity, specific surface area measured by krypton adsorption method (cm²/g), average thickness of the film, α, volume measured by mercury penetration method, pore size and number of particles were measured for each sample.

α

The specific surface area was measured by a Kr gas adsorption multipoint BET method. The bulk density of the surface layer was set at 4 g/cm³.

Volume Measured by Mercury Penetration Method; Pore Size

A porosimeter of mercury penetration system was used for measuring a range of pore size of 1 nm to 200 μm. The pore size has a relatively broad distribution. Therefore, each range of the pore size including main peaks were shown in table 4. 485 erg/cm² was applied as a surface tension value of mercury and 130° was applied as a contact angle.

Porosity

Porosity was measured using Archimedian method. In the examples C7 to C16, it was confirmed that pores in the film was substantially composed of open pores, judging from the ratio of the bulk density and the apparent density measured by Archimedian method.

Number of Particles

35 g of alumina powder used in the comparative example C1 was suspended in pure water of 100 to 1000 cc. Each of the samples of the examples C1 to C16 was immersed in the suspension and dried in atmosphere at 120° C. The process was repeated until the suspended state was disappeared, so that almost all the alumina particles were deposited onto the coated surface layer of the test sample. Fifty times of thermal cycles between room temperature and 200° C. were applied on the sample while holding the sample with its coated surface layer directed downwardly. After the thermal cycles, particles fallen on an Si wafer set under the sample were counted.

TABLE 3

| | | | Mean particle | Mean particle | Temperature | Ratio of peak | | |
|---|---|---|---|---|---|---|---|---|
| | | | Diameter of | diameter of | Of heat | strength | | |
| | | | Y2O3 powder | Al2O3 | Treatment | YAL (420)/ | Peel strength | Presence of |
| | | Production | (μm) | (μm) | (° C.) | YAG (420) | (MPa) | Cracks |
| C1 | Comparative | Sintered alumina | — | 20 | Sintered at | 0 | — | None |
| | example | Blast finishing | | | 1600° C. | | | |
| C2 | Comparative | Sintered alumina | YAG powder only | | Sintered at | 0 | — | None |
| | Example | Blast finishing | (40 μm) | | 1600° C. | | | |
| C3 | Comparative | Sintered YAG | YAG powder only | | Sintered at | 0 | — | None |
| | Example | | (40 μm) | | 1500° C. | | | |
| C4 | Comparative | Spraying of | YAG powder only | | 1600 ° C. | 0 | 4 | Present |
| | Example | YAG synthesized | (40 μm) | | | | | |
| | | Powder | | | | | | |
| C5 | Example | Spraying of mixed | 20 | 20 | No heat | 0.243 | 10 | None |
| | | powder | | | Treatment | | | |
| C6 | Example | Same as above | 20 | 20 | No heat | 0.210 | 10 | None |
| | | | | | Treatment | | | |
| C7 | Example | Same as above | 20 | 20 | No heat | 0.195 | 11 | None |
| | | | | | Treatment | | | |
| C8 | Example | Same as above | 20 | 20 | 1400 | 0.597 | 23 | None |
| C9 | Example | Same as above | 20 | 20 | 1400 | 0.541 | 19 | None |
| C10 | Example | Same as above | 20 | 20 | 1400 | 0.553 | 30 | None |
| C11 | Example | Same as above | 20 | 20 | 1600 | 0.803 | 52 | None |
| C12 | Example | Same as above | 20 | 20 | 1600 | 0.784 | 57 | None |
| C13 | Example | Same as above | 20 | 20 | 1600 | 0.792 | 53 | None |
| C14 | Example | Same as above | 50 | 50 | 1600 | 0.732 | 60 | None |
| C15 | Example | Same as above | 50 | 50 | 1600 | 0.718 | 62 | None |
| C16 | Example | Same as above | 50 | 50 | 1600 | 0.696 | 67 | None |

TABLE 4

| | | Weight gain | | | | | | | |
|---|---|---|---|---|---|---|---|---|---|
| | | after | | | | Ratio of | Volume by | | |
| | | Corrosion | | Kr | Average | Specific | Mercury | Range of | |
| | | test | Porosity | method | Thickness | surface area | Penetration | Pore size | Number of |
| | | mg/hr | % | cm2/g | (μm) | α | cc/g | (μm) | Particles |
| C1 | Comparative | 4.7 | <1 | 28 | 400 | 4 | 0.0064 | — | Many |
| | Example | | | | | | | | |
| C2 | Comparative | 0.0 | <1 | 9 | 400 | 1 | 0.0071 | — | Many |
| | Example | | | | | | | | |
| C3 | Comparative | 1.3 | 10 | 9,317 | 400 | 1,491 | 0.0302 | 0.08-2.5 | Many |
| | Example | | | | | | | | |
| C4 | Comparative | 1.0 | 4 | 710 | 60 | 17 | 0.0147 | 0.004-4 | Many |
| | Example | | | | | | | | |
| C5 | Example | 0.0 | 5 | 1,173 | 123 | 58 | 0.0062 | 0.05-8 | 200 |
| C6 | Example | 0.0 | 6 | 1,191 | 212 | 101 | 0.0070 | 0.05-8 | 50 |
| C7 | Example | 0.0 | 5 | 1,157 | 430 | 199 | 0.0063 | 0.05-8 | 50 |
| C8 | Example | 0.0 | 11 | 1,256 | 99 | 50 | 0.0111 | 0.05-8 | 0 |
| C9 | Example | 0.0 | 13 | 1,192 | 196 | 93 | 0.0131 | 0.05-8 | 0 |
| C10 | Example | 0.0 | 13 | 1,183 | 408 | 193 | 0.0128 | 0.05-8 | 0 |
| C11 | Example | 0.0 | 18 | 1,333 | 110 | 59 | 0.0379 | 0.05-14 | 0 |
| C12 | Example | 0.0 | 17 | 1,304 | 194 | 101 | 0.0390 | 0.05-14 | 0 |
| C13 | Example | 0.0 | 18 | 1,298 | 417 | 217 | 0.0401 | 0.05-14 | 0 |
| C14 | Example | 0.0 | 17 | 1,382 | 111 | 61 | 0.0443 | 0.2-20 | 0 |
| C15 | Example | 0.0 | 16 | 1,370 | 220 | 121 | 0.0452 | 0.2-20 | 0 |
| C16 | Example | 0.0 | 16 | 1,404 | 406 | 228 | 0.0493 | 0.2-20 | 0 |

The samples of C1 and C2 are dense sintered bodies and do not have holding capacity of particles on its surface. Many particles were thus fallen on the wafer from the sintered body. In C3, “α” was considerably increased because of insufficient sintering of YAG. Such insufficiency of sintering results in many fine open pores. In this case, even more particles were fallen after the thermal cycle. In C4, “α” of the surface layer is small and many particles were fallen. “Many particles” means approximately more than 10,000 per one wafer. In C5 to C16 according to the invention, the falling of particles on the wafer was considerably reduced. Particularly the samples of C8 to C16 were found to be superior. It is considered that each of the samples of C8 to C16 have higher a porosity than those of C5 to C7. C11 to C16 were superior in the view point of peel strength.

Among the inventive examples, a mixed powder of powdery materials of yttria and alumina were sprayed to produce a sprayed film in C5 to C16. The samples in C5, C6 and C7, the sprayed film was not subjected to a heat treatment and the porosity was lower than 10 percent. In the samples of C8 to C16, the porosity of the film was increased to a value higher than 10 percent as a result of a heat treatment.

Moreover, in the samples of C5 to C16, the ratio of peak strengths were in a range of 0.05 to 1.5, the peel strength was therefore large without cracks observed.

Example C17

Talc with a particle diameter of 10 μm, fused quartz and alumina powder with a particle diameter of 25 μm were mixed with methyl cellulose and water and kneaded to produce a paste, which was then applied on an alumina substrate having a length of 150 mm, width of 150 mm and thickness of 5 mm as in the examples C4 to C16. The substrate was then subjected to a heat treatment in atmosphere at 1400° C. The steps of applying the paste and the subsequent heat treatment were repeated several times to form a cordierite layer having an average thickness of 120 μm. A bulk density of 2.0 g/cm² was used for calculating the “α” value.

The peel strength of the film was 36 MPa without cracks observed. The weight gain after the corrosion resistant test was −0.3 mg/hour, the porosity was 21 percent, average thickness was 120 μm, α was 139, volume measured by mercury penetration method was 0.102 cc/g, the rage of pore size was 1 to 40 μm and number of particles was 0.

Example C18

Diamond film was formed on a substrate made of silicon nitride. The substrate was produced by mixing α type silicon nitride powder having a particle diameter of about 1 μm, 5 mol percent of Y₂O₃, 2 mol percent of Al₂O₃, and 5 mol percent of β type silicon nitride and subjecting the mixture to a heat treatment in nitrogen atmosphere at 1850° C. to obtain a densified body. The substrate has the same shape and dimensions as those in the example 17. A film of diamond with a thickness of about 50 μm was produced on the substrate by a microwave CVD process. Quartz glass was set around the substrate to add Si and oxygen into the diamond film. The substrate was then exposed to a down flow plasma of a mixed gas of NF₃ and Ar for 10 hours, while maintaining the temperature of the substrate in a range from 150 to 300° C., so that micro pore structure may be formed. A bulk density of 3.2 g/cm³ was used for calculating the “α” value.

The peel strength of the film was 54 MPa without cracks observed. The weight gain after the corrosion resistant test was 0.0 mg/hour, the porosity was 10 percent, average thickness was 50 μm, a was 53, and number of particles was 0.

As described above, the present invention may provide a member having a capability of holding deposits firmly on the surface, so that particles due to the surface deposits may be reduced.

The present invention has been explained referring to the preferred embodiments. The invention is, however, not limited to the illustrated embodiments which are given by way of examples only, and may be carried out in various modes without departing from the scope of the invention.

1. A method of producing a film of an yttria-alumina complex oxide, the method comprising the step of:
spraying a mixed powder of powdery materials of yttria and alumina onto a substrate to produce a sprayed film composed of an yttria-alumina complex oxide.

2. The method of claim 1, wherein said powdery material of yttria has a 50 percent mean particle diameter of not smaller than 0.1 μm and not larger than 100 μm.

3. The method of claim 1, wherein said powdery material of alumina has a 50 percent mean particle diameter of not smaller than 0.1 μm and not larger than 100 μm.

4. The method of claim 1, comprising the step of subjecting said sprayed film to a heat treatment.

5. The method of claim 1, wherein said yttria-alumina complex oxide includes at least garnet phase.

6. A film of an yttria-alumina complex oxide, obtained by the method of claim 1.

7. The film of claim 6 free from a crack having a length of not smaller than 3 μm and a width of not smaller than 0.1 μm.

8. The film of claim 6, wherein said yttria-alumina complex oxide comprises those of garnet and perovskite phases and a ratio YAL(420)/YAG(420) is not lower than 0.05 and not higher than 1.5, provided that said ratio YAL(420)/YAG(420) is the ratio of a peak strength YAL (420) of the (420) plane of said perovskite phase to a peak strength YAG (420) of the (420) plane of said garnet phase, said peak strengths being measured by X-ray diffraction method.

9. A film of an yttria-alumina complex oxide, wherein said yttria-alumina complex oxide comprises those of garnet and perovskite phases and a ratio YAL(420)/YAG(420) is not lower than 0.05 and not higher than 1.5, provided that said ratio YAL(420)/YAG(420) is the ratio of a peak strength YAL (420) of the (420) plane of said perovskite phase to a peak strength YAG (420) of the (420) plane of said garnet phase, said peak strengths being measured by X-ray diffraction method.

10. The film of claim 9, free from a crack having a length of not smaller than 3 μm and a width of not smaller than 0.1 μm.

11. The film of claim 9 formed by spraying.

12. A film formed by spraying, said film being made of an yttria-alumina complex oxide and free from a crack having a length of not smaller than 3 μm and a width of not smaller than 0.1 μm.

13. The film of claim 12, wherein said yttria-alumina complex oxide comprises those of garnet and perovskite phases and a ratio YAL(420)/YAG(420) is not lower than 0.05 and not higher than 1.5, provided that said ratio YAL(420)/YAG(420) is the ratio of a peak strength YAL (420) of the (420) plane of said perovskite phase to a peak strength YAG (420) of the (420) plane of said garnet phase, said peak strengths being measured by X-ray diffraction method.

14. A corrosion-resistant member comprising a substrate and a film of an yttria-alumina complex oxide, wherein said yttria-alumina complex oxide comprises those of garnet and perovskite phases and a ratio YAL(420)/YAG(420) is not lower than 0.05 and not higher than 1.5, provided that said ratio YAL(420)/YAG(420) is the ratio of a peak strength YAL (420) of the (420) plane of said perovskite phase to a peak strength YAG (420) of the (420) plane of said garnet phase, said peak strengths being measured by X-ray diffraction method.

15. The corrosion-resistant member of claim 14, free from a crack having a length of not smaller than 3 μm and a width of not smaller than 0.1 μm.

16. The corrosion resistant member of claim 14, wherein said film is formed by spraying.

17. The corrosion-resistant member of claim 14, wherein a peeling strength of said film to said substrate is not lower than 10 MPa.

18. A corrosion-resistant member comprising a substrate and a film formed by spraying, wherein said film is made of an yttria-alumina complex oxide and free from a crack having a length of not smaller than 3 μm and a width of not smaller than 0.1 μm.

19. The corrosion-resistant member of claim 18, wherein said yttria-alumina complex oxide comprises those of garnet and perovskite phases and a ratio YAL(420)/YAG(420) is not lower than 0.05 and not higher than 1.5, provided that said ratio YAL(420)/YAG(420) is the ratio of a peak strength YAL (420) of the (420) plane of said perovskite phase to a peak strength YAG (420) of the (420) plane of said garnet phase, said peak strengths being measured by X-ray diffraction method.

20. The corrosion-resistant member of claim 18, wherein a peeling strength of said film to said substrate is not lower than 10 MPa.

21. The corrosion-resistant member of claim 14, wherein said member is to be exposed against a halogen gas or a plasma of a halogen gas.

22. A member effective for reducing particle generation and comprising a substrate and a surface layer on said substrate, wherein said surface layer has a calculated according to the following formula of not lower than 50 and not higher than 700.
α=(a specific surface area measured by Krypton adsorption method (cm²/g))×(a thickness of said surface layer (cm))×(a bulk density of said surface layer (g/cm³))

23. The member of claim 22, wherein said surface layer has an open porosity of not lower than 10 volume percent and not higher than 30 volume percent.

24. The member of claim 22, wherein said surface layer has a ratio of an open porosity to a closed porosity (open porosity/closed porosity) of not higher than 10.

25. The member of claim 22, wherein said surface layer has a pore diameter of main open pores of 0.05 to 50 μm.

26. The member of claim 22, wherein said surface layer has a thickness of not smaller than 50 μm.

27. The member of claim 22, wherein said surface layer is made of a material selected from the group consisting of an oxide containing a rare earth element, an oxide containing an alkaline earth element, a carbide, a nitride, a fluoride, a chloride, an alloy, a solid solution thereof and a mixture thereof.

28. The member of claim 22, wherein said surface layer is made of a compound containing yttrium.

29. The member of claim 28, wherein said surface layer contains an yttria-alumina complex oxide.

30. The member of claim 22, wherein said member is to be exposed to a corrosive substance and a material constituting said substrate has an etching rate against said corrosive substance larger than that of a material constituting said surface layer.

31. The member of claim 30, wherein said corrosive substance is a halogen gas or a plasma of a halogen gas.

32. The substrate of claim 22, wherein said substrate is made of a material selected from the group consisting of alumina, spinel, yttria, zirconia and the complex oxide thereof.

33. The member of claim 28, wherein said surface layer is a film made of an yttria-alumina complex oxide, said film being formed by spraying a mixed powder of powdery materials of yttria and alumina on said substrate.

34. The member of claim 33, wherein said powdery material of yttria has a 50 percent mean particle diameter of not smaller than 0.1 μm and not larger than 100 μm.

35. The member of claim 33, wherein said powdery material of alumina has a 50 percent mean particle diameter of not smaller than 0.1 μm and not larger than 100 μm.

36. The member of claim 33, wherein said film is thermally treated.

37. The member of claim 33, wherein said yttria-alumina complex oxide includes at least garnet phase.

38. The member of claim 37, wherein said yttria-alumina complex oxide comprises those of garnet and perovskite phases and a ratio YAL(420)/YAG(420) is not lower than 0.05 and not higher than 1.5, provided that said ratio YAL(420)/YAG(420) is the ratio of a peak strength YAL (420) of the (420) plane of said perovskite phase to a peak strength YAG (420) of the (420) plane of said garnet phase, said peak strengths being measured by X-ray diffraction method.
